(19) United States
(12) Patent Application Publication
(10) Pub. No.: US 2025/0293447 A1
(43) Pub. Date: Sep. 18, 2025

(54) CONNECTOR ASSEMBLY

(71) Applicant: JAPAN AVIATION ELECTRONICS INDUSTRY, LIMITED, Tokyo (JP)

(72) Inventor: Kenta ASHIBU, Tokyo (JP)

(73) Assignee: JAPAN AVIATION ELECTRONICS INDUSTRY, LIMITED, Tokyo (JP)

(21) Appl. No.: 19/044,870

(22) Filed: Feb. 4, 2025

(30) Foreign Application Priority Data
Mar. 15, 2024 (JP) 2024-041243

(51) Int. Cl. H01R 12/75; H01R 12/72

(52) U.S. Cl. CPC H01R 12/75; H01R 12/722

(57) ABSTRACT

A connector assembly comprises a coaxial connector and a fixed member. The coaxial connector comprises an outer terminal which has a flange portion and two projecting portions. The flange portion has a first receiving portion. Each of the projecting portions is provided with a second receiving portion. The fixed member has a spring portion, a first contact portion and two second contact portions. The fixed member has a distance between the first contact portion and any of the two second contact portions in a front-rear direction. The distance is variable by resilient deformation of the spring portion. Under a connected state where the connector assembly is connected to a substrate, the resilient deformation of the spring portion enables that the first contact portion is pressed against the first receiving portion while the two second contact portions are pressed against the second receiving portions of the two projecting portions, respectively.

### CROSS REFERENCE TO RELATED APPLICATIONS

This application is based on and claims priority under 35 U.S.C. § 119 to Japanese Patent Applications No. JP 2024-041243 filed Mar. 15, 2024, the contents of which are incorporated herein in their entirety by reference.

### BACKGROUND OF THE INVENTION

This invention relates to a connector assembly which is configured to be connected to a substrate.

For example, JPB 6853655 (Patent Document 1) discloses a connector assembly which is configured to be connected to a substrate.

Referring to FIGS. 26 and 27, a substrate-connector connection structure 900 of Patent Document 1 has a substrate 950 and a connector 910, or a connector assembly 910. Specifically, the connector assembly 910 is connected to the substrate 950. The substrate 950 has a signal pattern 952, or a signal line 952, a first ground layer 954 and a plating layer 956. Specifically, the plating layer 956 is located just below the signal line 952 and is formed at a region including an end surface of the first ground layer 954. The connector assembly 910 comprises a coaxial connector 920 and two screws 930, or fixing members 930. The coaxial connector 920 has a center conductor 922, or a center terminal 922, and an outer conductor 924, or an outer terminal 924. When the connector assembly 910 is connected to the substrate 950, the outer terminal 924 is brought into contact with the plating layer 956 which is electrically connected to the first ground layer 954. By this structure, the substrate-connector connection structure 900 of Patent Document 1 is configured to reduce reflection characteristics of signals propagating between the substrate 950 and the connector assembly 910.

In the substrate-connector connection structure 900 of Patent Document 1, it is difficult for the outer terminal 924 of the coaxial connector 920 to be stably connected to the plating layer 956 of the substrate 950 when the connector assembly 910 is connected to the substrate 950. Accordingly, the substrate-connector connection structure 900 of Patent Document 1 might not make a reliable electrical connection between the outer terminal 924 and the first ground layer 954.

### SUMMARY OF THE INVENTION

It is therefore an object of the present invention to provide a connector assembly which enables an outer terminal of a coaxial connector of the connector assembly to be stably connected to a ground layer of a substrate.

One aspect of the present invention provides a connector assembly configured to be connected to a substrate. The substrate is formed with two passing holes. Each of the passing holes passes through the substrate in an up-down direction. The substrate has an upper surface and a lower surface in the up-down direction. The upper surface of the substrate is formed with a signal line. The signal line is located between the two passing holes in a lateral direction perpendicular to the up-down direction. The lower surface of the substrate is formed with a ground layer. The connector assembly comprises a coaxial connector, a fixed member and two screws. The coaxial connector is configured to be attached to a distal end of a coaxial cable. The coaxial connector comprises an outer terminal and a center terminal. The outer terminal has a flange portion and two projecting portions. The flange portion has a first receiving portion. The first receiving portion faces forward in a front-rear direction perpendicular to both the up-down direction and the lateral direction. The two projecting portions are apart from each other in the lateral direction. Each of the projecting portions extends forward in the front-rear direction from the flange portion. Each of the projecting portions is formed with a screw hole. Each of the projecting portions is provided with a second receiving portion. The second receiving portion faces at least rearward in the front-rear direction. The fixed member is made of metal. A part of the fixed member is located below the substrate in the up-down direction under a connected state where the connector assembly is connected to the substrate. The ground layer of the substrate is electrically connected to the first receiving portion of the flange portion via the fixed member under the connected state. The fixed member is formed with two fixing holes. Each of the fixing holes passes through the fixed member in the up-down direction. The fixed member has a spring portion, a first contact portion and two second contact portions. The spring portion is resiliently deformable and supports all of the first contact portion and the two second contact portions. The first contact portion is located rearward of any of the two second contact portions in the front-rear direction. The two second contact portions are apart from each other in the lateral direction. The fixed member has a distance between the first contact portion and any of the two second contact portions in the front-rear direction. The distance is variable by resilient deformation of the spring portion. Under the connected state, the resilient deformation of the spring portion enables that the first contact portion is pressed against the first receiving portion while the two second contact portions are pressed against the second receiving portions of the two projecting portions, respectively. Under the connected state, the screws are screwed into the screw holes of the projecting portions through the fixing holes and the passing holes, respectively, and thereby the screws are fixed to the projecting portions, respectively, while the screws press the fixed member against the ground layer of the substrate.

The connector assembly of the present invention is configured so that, under the connected state where the connector assembly is connected to the substrate, the resilient deformation of the spring portion of the fixed member enables that the first contact portion of the fixed member is pressed against the first receiving portion of the flange portion of the outer terminal of the coaxial connector while the two second contact portions of the fixed member are pressed against the second receiving portions of the two projecting portions, respectively, of the outer terminal of the coaxial connector. Accordingly, the connector assembly of the present invention is configured so that the fixed member is securely connected to the outer terminal of the coaxial connector. Thus, the ground layer of the substrate is electrically connected to the first receiving portion of the flange portion of the outer terminal via the fixed member in a highly reliable manner when the connector assembly of the present invention is connected to the substrate. In other words, the connector assembly of the present invention enables the outer terminal of the coaxial connector of the connector assembly to be stably connected to the ground layer of the substrate.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a structure according to an embodiment of the present invention. In the figure, a connector assembly is under a connected state where the connector assembly is connected to a substrate.

FIG. 2 is another perspective view showing the structure of FIG. 1.

FIG. 3 is a top view showing the structure of FIG. 1.

FIG. 4 is a front view showing the structure of FIG. 1.

FIG. 5 is a bottom view showing the structure of FIG. 1.

FIG. 6 is a side view showing the structure of FIG. 1. In the figure, a part of the structure is enlarged and illustrated.

FIG. 7 is a rear view showing the structure of FIG. 1.

FIG. 8 is an exploded, perspective view showing the structure of FIG. 1. In the figure, a coaxial connector is under a pre-connected state where the coaxial connector is not yet connected to the substrate.

FIG. 9 is another exploded, perspective view showing the structure of FIG. 2. In the figure, the coaxial connector is under the pre-connected state where the coaxial connector is not yet connected to the substrate.

FIG. 10 is a top view showing the coaxial connector which is included in the structure of FIG. 8.

FIG. 11 is a bottom view showing the coaxial connector of FIG. 10.

FIG. 12 is a side view showing the coaxial connector of FIG. 10.

FIG. 13 is a rear view showing the coaxial connector of FIG. 10.

FIG. 14 is a perspective view showing a fixed member which is included in the structure of FIG. 8.

FIG. 15 is another perspective view showing the fixed member of FIG. 14.

FIG. 16 is a top view showing the fixed member of FIG. 14.

FIG. 17 is a bottom view showing the fixed member of FIG. 14.

FIG. 18 is a front view showing the fixed member of FIG. 14.

FIG. 19 is a side view showing the fixed member of FIG. 14.

FIG. 20 is a perspective view showing a first modification of the fixed member of FIG. 14.

FIG. 21 is another perspective view showing the fixed member of FIG. 20.

FIG. 22 is a perspective view showing a second modification of the fixed member of FIG. 14.

FIG. 23 is another perspective view showing of the fixed member of FIG. 22.

FIG. 24 is a perspective view showing a third modification of the fixed member of FIG. 14.

FIG. 25 is a perspective view showing a fourth modification of the fixed member of FIG. 14.

FIG. 26 is a perspective view showing a substrate-connector connection structure of Patent Document 1.

FIG. 27 is a cross-sectional view showing a part of the substrate-connector connection structure of FIG. 26.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

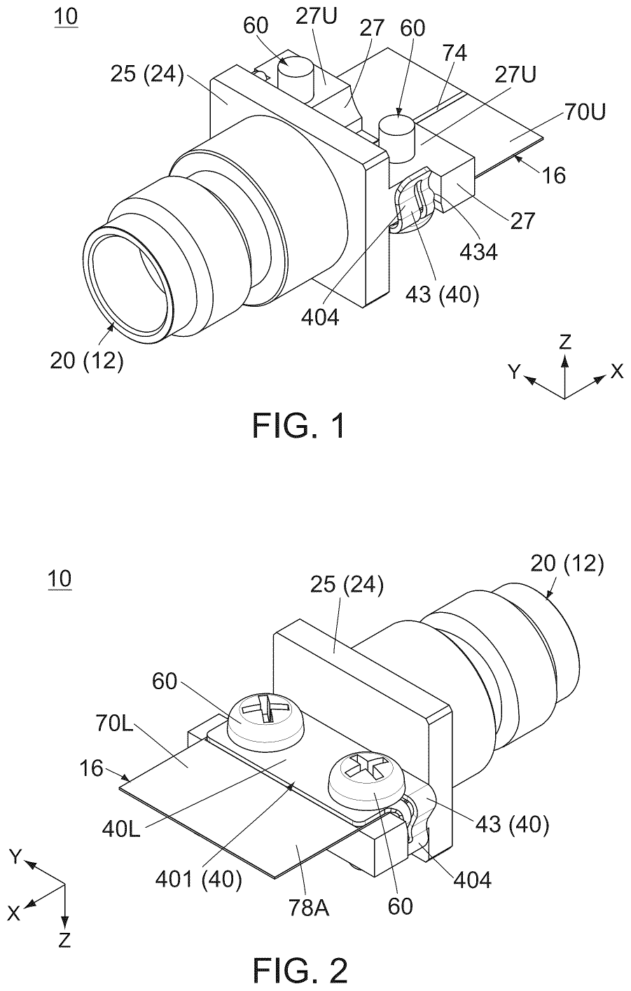

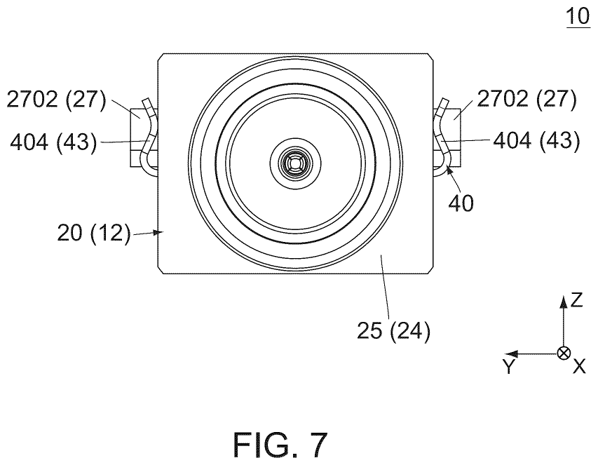

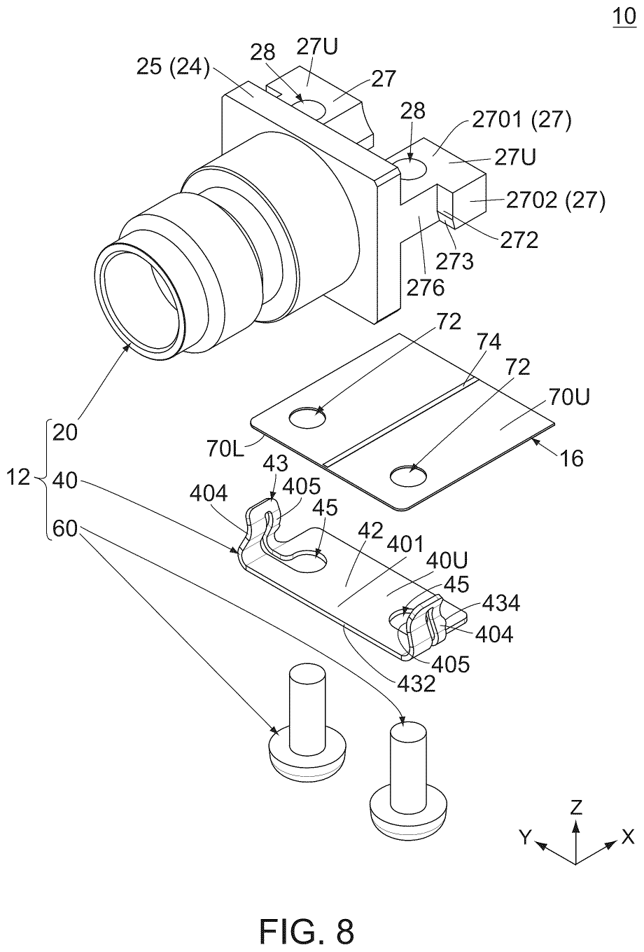

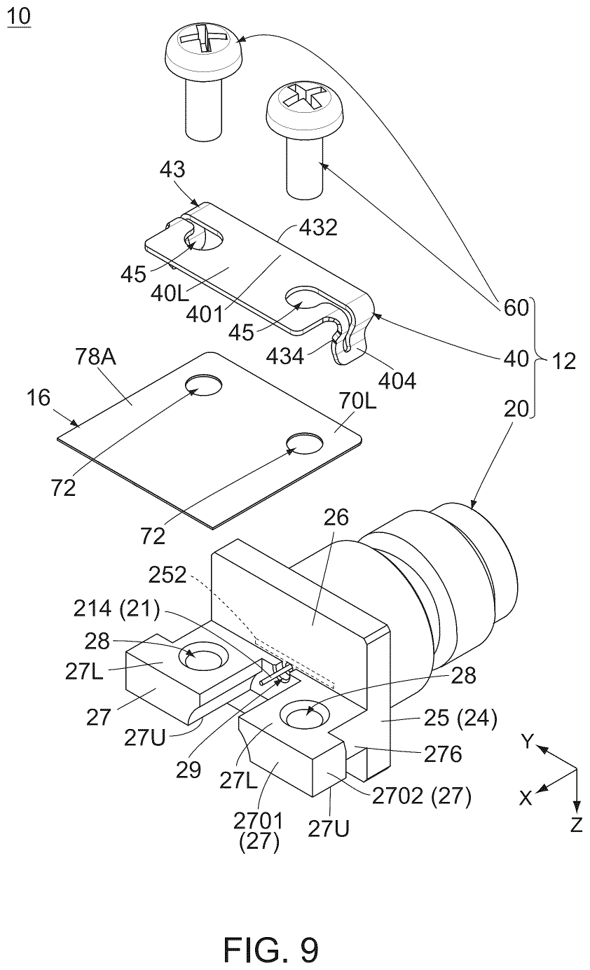

Referring to FIG. 2, a structure 10 according to an embodiment of the present invention comprises a connector assembly 12 and a substrate 16. The substrate 16 extends along a horizontal plane. The connector assembly 12 is configured to be connected to the substrate 16. In detail, the connector assembly 12 is configured to be connected to a rear end portion of the substrate 16 in a front-rear direction parallel to the horizontal plane. The connector assembly 12 of each of FIGS. 1 to 7 is under a connected state where the connector assembly 12 is connected to the substrate 16. In contrast, the connector assembly 12 of each of FIGS. 8 and 9 is under a pre-connected state where the connector assembly 12 is not yet connected to the substrate 16.

The horizontal plane of the present embodiment is an XY-plane. The front-rear direction of the present embodiment is an X-direction. In the present embodiment, “forward” means a positive X-direction, and “rearward” means a negative X-direction. The words such as the horizontal plane and the front-rear direction do not indicate the absolute positional relation relative to the ground but merely indicate a relative positional relation under a definition where the substrate 16 extends in the horizontal plane and where the connector assembly 12 is located rearward of this substrate 16.

Referring to FIGS. 8 and 9, the substrate 16 is not specifically limited. The substrate 16 may be a flexible board, or may be a rigid board.

As shown in FIGS. 8 and 9, the substrate 16 has an upper surface 70U and a lower surface 70L in an up-down direction perpendicular to the horizontal plane. The upper surface 70U and the lower surface 70L are located at an upper end and a lower end of a base 70, respectively. The up-down direction of the present embodiment is a Z-direction. In the present embodiment, “upward” means a positive Z-direction, and “downward” means a negative Z-direction.

As shown in FIG. 8, the substrate 16 is formed with two passing holes 72. Each of the passing holes 72 passes through the substrate 16 in the up-down direction. Each of the passing holes 72 has a circular shape in the horizontal plane. The thus-formed passing holes 72 are used when the connector assembly 12 is screwed to the substrate 16 as described later. The two passing holes 72 are apart from each other in a lateral direction perpendicular to both the front-rear direction and the up-down direction and are located at positions same as each other in the front-rear direction. The lateral direction of the present embodiment is a Y-direction. In addition, the lateral direction is also referred to as a right-left direction. In the present embodiment, “rightward” means a positive Y-direction, and “leftward” means a negative Y-direction.

The passing holes 72 of the present embodiment are formed as described above. However, the present invention is not limited thereto. For example, the shape of each of the passing holes 72 is not specifically limited. Moreover, the number of the passing holes 72 may be three or more. In this instance, two of the passing holes 72 may be apart from each other in the lateral direction and may be located at positions same as each other in the front-rear direction.

As shown in FIG. 8, the upper surface 70U of the substrate 16 is formed with a signal line 74 which is a conductive pattern. The signal line 74 extends in the front-rear direction and is located between the two passing holes 72 in the lateral direction.

As shown in FIG. 9, the lower surface 70L of the substrate 16 is formed with a ground layer 78A which is a conductive pattern and covers the whole of the lower surface 70L.

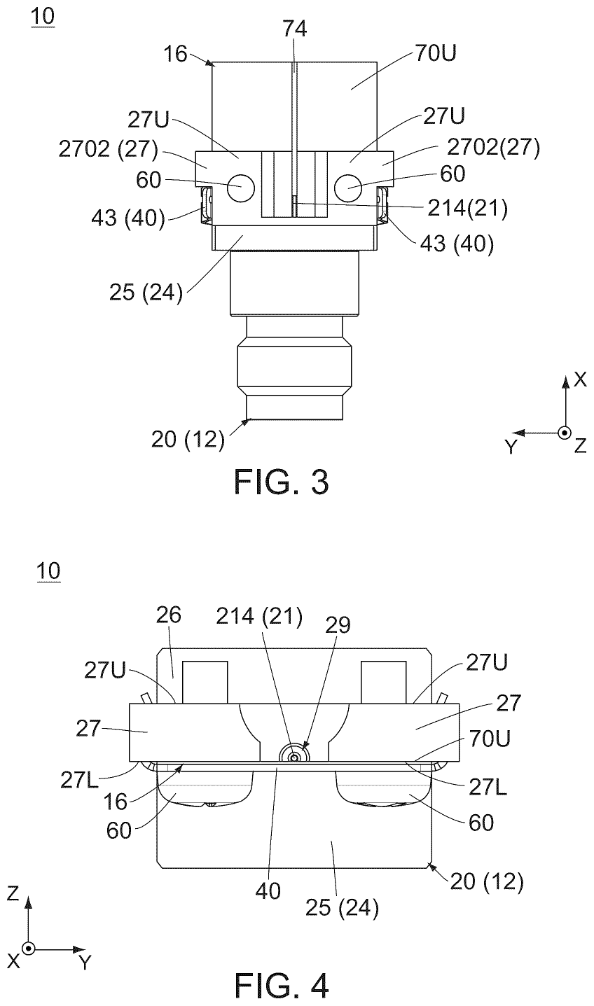

Referring to FIG. 3, the signal line 74 of an instance is connected to an antenna which is formed on an unillustrated front end part of the substrate 16. In this instance, the connector assembly 12 under the connected state transmits signals to the antenna through the signal line 74. The thus-transmitted signals are sent outward from the antenna. On the other hand, signals received by the antenna are transmitted to the connector assembly 12 through the signal line 74. The structure 10 of the present embodiment is uses as described above, for example. In other words, the structure 10 of the present embodiment is an antenna device. However, the usage of the structure 10 of the present invention is not specifically limited.

The substrate 16 of the present embodiment has the aforementioned configuration. However, the configuration of the substrate 16 can be modified in accordance with the usage of the structure 10. For example, the ground layer 78A may be partially formed on the lower surface 70L.

Referring to FIG. 9, the connector assembly 12 of the present embodiment comprises a coaxial connector 20, a fixed member 40 and two screws 60. The connector assembly 12 of the present embodiment comprises only the aforementioned members. However, the present invention is not limited thereto. For example, the connector assembly 12 may further comprise another member in addition to the aforementioned members.

Hereafter, explanation will be made about the coaxial connector 20, the fixed member 40 and the screws 60 of the present embodiment in this order.

Referring to FIG. 6, the coaxial connector 20 of the present embodiment is configured to be attached to a distal end of a coaxial cable 80. Specifically, the coaxial connector 20 is configured to be attached to a front end of the coaxial cable 80. The coaxial connector 20 of the present embodiment is a so-called sub miniature type A (SMA) connector. However, the present invention is not limited thereto but applicable to various coaxial connectors 20.

Referring to FIG. 6, the coaxial cable 80 illustrated with dashed line is a typical coaxial cable and comprises a center conductor (not shown) made of conductor, an inner insulator (not shown) made of insulator and covering the center conductor, an outer conductor (not shown) made of conductor and covering the inner insulator and a sheath 88 made of insulator and covering the outer conductor. The number of the center conductor of the present embodiment is one. The configuration of the coaxial cable 80 is not specifically limited, provided that the number of the center conductor is one. For example, the outer conductor may be a braid formed of fine metal wires or may be made of metal foil. For example, the coaxial cable 80 may be connected to a rear end of the coaxial connector 20 via a mating connector (not shown) attached to the coaxial cable 80.

Referring to FIG. 9, the coaxial connector 20 of the present embodiment comprises a center terminal 21 made of metal and an outer terminal 24 made of metal.

As shown in FIG. 3, the center terminal 21 of the present embodiment extends along the front-rear direction and has a contact portion 214. The contact portion 214 defines a front end of the center terminal 21 in the front-rear direction. Referring to FIGS. 3 and 6, the center terminal 21 is connected with the center conductor of the coaxial cable 80 when the coaxial connector 20 is attached to the coaxial cable 80. The center terminal 21 and the center conductor connected to each other transmit signals to each other.

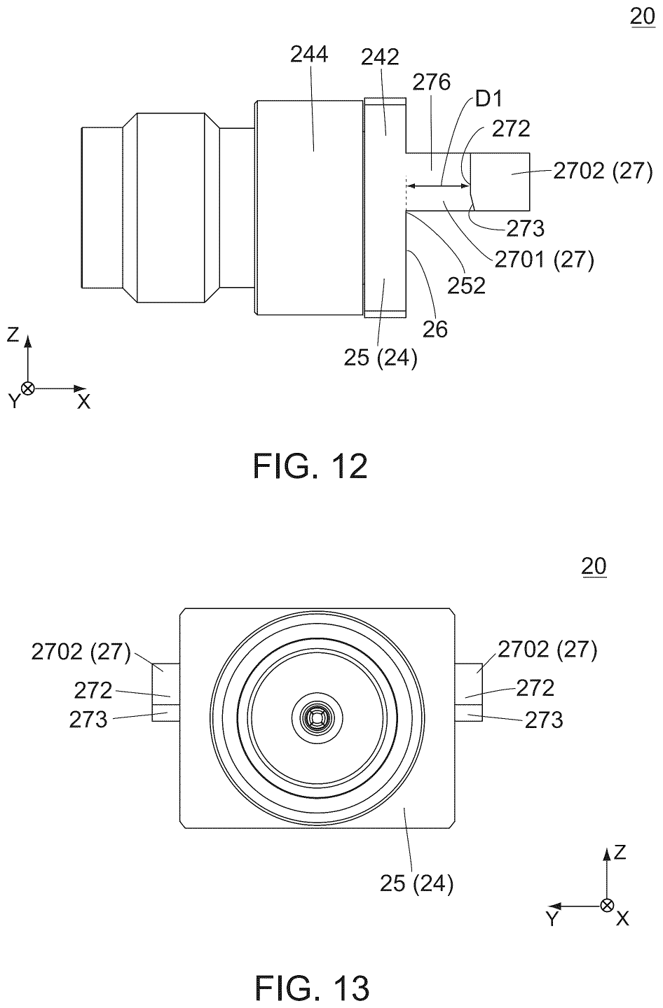

As shown in FIG. 12, the outer terminal 24 of the present embodiment comprises a front conductive member 242 and a rear conductive member 244. The front conductive member 242 is combined with the rear conductive member 244 and is located forward of the rear conductive member 244. The front conductive member 242 is in contact with the rear conductive member 244. The outer terminal 24 of the present embodiment consists of the aforementioned two members. However, the present invention is not limited thereto. For example, the front conductive member 242 and the rear conductive member 244 may be a member integrally formed with each other.

Referring to FIG. 6, the outer terminal 24 is connected with the outer conductor of the coaxial cable 80 when the coaxial connector 20 is attached to the coaxial cable 80. In detail, the rear conductive member 244 of the outer terminal 24 is configured to be electrically connected with the outer conductor. The outer terminal 24 and the outer conductor connected to each other have ground potentials same as each other.

As shown in FIG. 9, the outer terminal 24 has a flange portion 25 and two projecting portions 27.

As shown in FIG. 9, the flange portion 25 of the present embodiment has a first receiving portion 252.

As shown in FIG. 9, the first receiving portion 252 faces forward in the front-rear direction perpendicular to both the up-down direction and the lateral direction. The first receiving portion 252 is located around a middle of the flange portion 25 in the up-down direction. The first receiving portion 252 is located at a middle of the flange portion 25 in the lateral direction. Referring to FIGS. 2 and 9, under the connected state, the ground layer 78A of the substrate 16 is electrically connected to the first receiving portion 252 of the flange portion 25 via the fixed member 40.

As shown in FIG. 9, the flange portion 25 further has an end surface 26. The end surface 26 of the present embodiment is a plane parallel to a YZ-plane. The first receiving portion 252 is a part of the end surface 26 of the flange portion 25. The contact portion 214 of the center terminal 21 is located forward of the end surface 26. The contact portion 214 extends forward in the front-rear direction beyond the end surface 26.

As shown in FIG. 9, the two projecting portions 27 of the present embodiment are apart from each other in the lateral direction. The contact portion 214 is located between the two projecting portions 27 in the lateral direction. Each of the two projecting portions 27 extends forward in the front-rear direction from the flange portion 25. Each of the two projecting portions 27 projects forward form the end surface 26. The two projecting portions 27 of the present embodiment have a mirror symmetric shape with respect to a plane perpendicular to the lateral direction. The thus-arranged two projecting portions 27 are located at positions same as each other in the up-down direction. Each of the projecting portions 27 has an upper surface 27U and a lower surface 27L in the up-down direction. Each of the upper surface 27U and the lower surface 27L is a flat surface in parallel to the horizontal plane. The upper surface 27U defines an upper end of the projecting portion 27 in the up-down direction. The lower surface 27L defines a lower end of the projecting portion 27 in the up-down direction.

As shown in FIG. 9, each of the projecting portions 27 of the present embodiment is formed with a screw hole 28. Each of the screw holes 28 of the present embodiment passes through the projecting portion 27 in the up-down direction. The screw holes 28 are provided at positions which correspond to those of the passing holes 72, respectively, of the substrate 16 in the horizontal plane. Specifically, the two screw holes 28 are apart from each other in the lateral direction and are located at positions same as each other in the front-rear direction. The number of the screw holes 28 of the present embodiment is two. However, the present invention is not limited thereto. For example, each of the projecting portions 27 may be formed with two or more of the screw holes 28. Each of the screw holes 28 may be a hole with a ceiling.

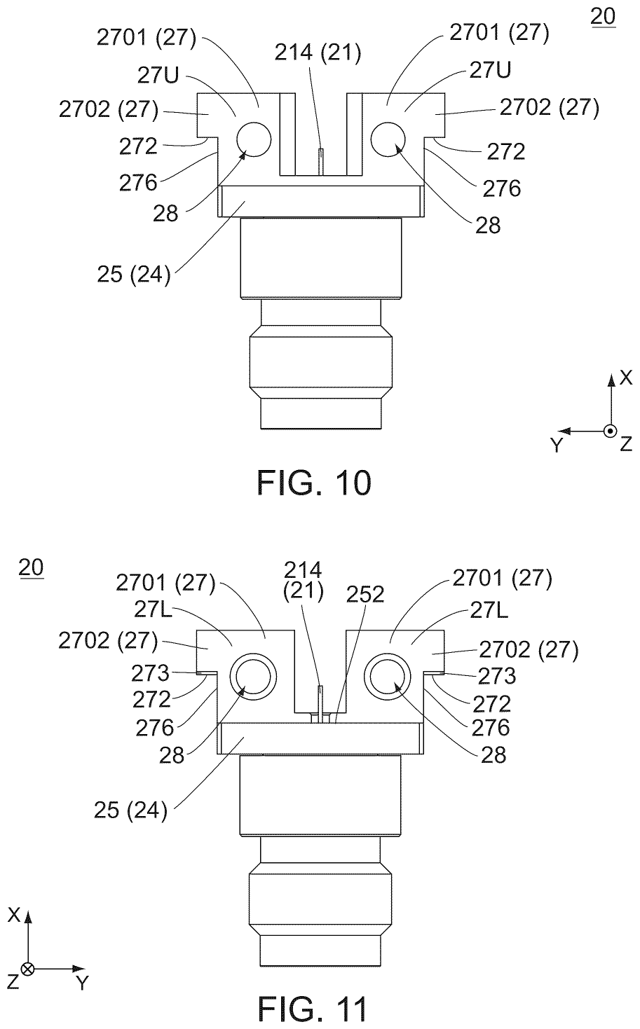

As shown in FIG. 10, each of the projecting portions 27 of the present embodiment is formed with a second receiving portion 272.

As shown in FIG. 8, the second receiving portion 272 of the present embodiment faces rearward in the front-rear direction. However, the present invention is not limited thereto. Specifically, the second receiving portion 272 should face at least rearward in the front-rear direction. As shown in FIG. 10, the second receiving portion 272 is located around an outer end of the projecting portion 27 in the lateral direction. The second receiving portion 272 is located forward of the flange portion 25 in the front-rear direction. Referring to FIGS. 10 and 11, the second receiving portion 272 is located forward of the first receiving portion 252 in the front-rear direction. As shown in FIG. 11, the second receiving portion 272 is located forward of the contact portion 214 in the front-rear direction. As shown in FIG. 12, the coaxial connector 20 has a first distance D1 between the first receiving portion 252 and any of the second receiving portions 272 in the front-rear direction

As shown in FIG. 12, each of the projecting portions 27 is provided with a guide portion 273. However, the present invention is not limited thereto, but the projecting portion 27 may be provided with no guide portion 273.

As shown in FIG. 12, the guide portion 273 is located below the second receiving portion 272 in the up-down direction. The guide portion 273 intersects with the front-rear direction. More in detail, the guide portion 273 is oblique to the front-rear direction. The guide portion 273 intersects with the up-down direction. More in detail, the guide portion 273 is oblique to the up-down direction. Specifically, the guide portion 273 extends upward and rearward.

As shown in FIG. 12, each of the projecting portions 27 is provided with a third receiving portion 276. However, the present invention is not limited thereto, but the projecting portion 27 may be provided with no third receiving portion 276.

As shown in FIG. 8, the third receiving portion 276 of the present embodiment faces outward in the lateral direction. The third receiving portion 276 is a plane perpendicular to the lateral direction. In each of the projecting portions 27, the third receiving portion 276 is located inward of the second receiving portion 272 in the lateral direction. In each of the projecting portions 27, the third receiving portion 276 is located above the second receiving portion 272 in the up-down direction. As shown in FIG. 9, the third receiving portion 276 is located forward of the first receiving portion 252 in the front-rear direction. The third receiving portion 276 is located outward of the center terminal 21 in the lateral direction. The third receiving portion 276 is located above the center terminal 21 in the up-down direction. The third receiving portion 276 is located above the first receiving portion 252 in the up-down direction.

As shown in FIG. 9, each of the projecting portions 27 has a first portion 2701 and a second portion 2702.

As shown in FIG. 10, the first portion 2701 of the present embodiment extends forward in the front-rear direction from the flange portion 25. The screw hole 28 is provided at the first portion 2701. The third receiving portion 276 is provided on the first portion 2701. More specifically, the third receiving portion 276 is a part of an outer surface of the first portion 2701 in the lateral direction.

As shown in FIG. 10, the second portion 2702 of the present embodiment projects outward in the lateral direction from the first portion 2701. The second portion 2702 defines the outer end of the projecting portion 27 in the lateral direction. The second receiving portion 272 is provided on the second portion 2702. More in detail, the second receiving portion 272 is a part of a rear surface of the second portion 2702 in the front-rear direction.

As shown in FIG. 4, the outer terminal 24 of the present embodiment is formed with a center hole 29. The center hole 29 has a circular shape in the YZ-plane. The center hole 29 is located between the two projecting portions 27 in the lateral direction. The center terminal 21 is located at the center of the center hole 29 in the YZ-plane.

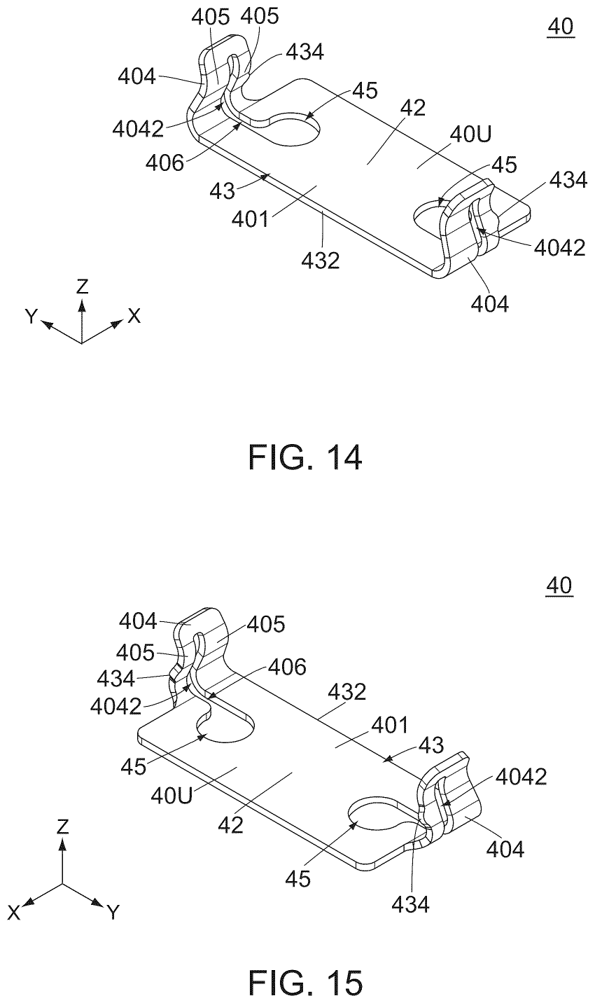

As shown in FIG. 6, a part of the fixed member 40 is located below the substrate 16 in the up-down direction under the connected state where the connector assembly 12 is connected to the substrate 16. Referring to FIGS. 2 and 9, the fixed member 40 is in contact with the ground layer 78A of the substrate 16 under the connected state where the connector assembly 12 is connected to the substrate 16. As shown in FIG. 6, the fixed member 40 is in contact with the outer terminal 24 under the connected state. Referring to FIG. 14, the fixed member 40 is made of metal. More in detail, the fixed member 40 is formed by punching out a metal plate, followed by bending the metal plate. It is noted that the fixed member 40 is preferred to have a surface treatment such as, for example, gold plating in order to make reliable contact with the substrate 16 and the outer terminal 24.

As shown in FIG. 14, the fixed member 40 has a spring portion 43, a first contact portion 432 and two second contact portions 434.

Referring to FIG. 14, the spring portion 43 of the present embodiment is resiliently deformable and supports all of the first contact portion 432 and the two second contact portions 434. The spring portion 43 defines a rear end of the fixed member 40 in the front-rear direction.

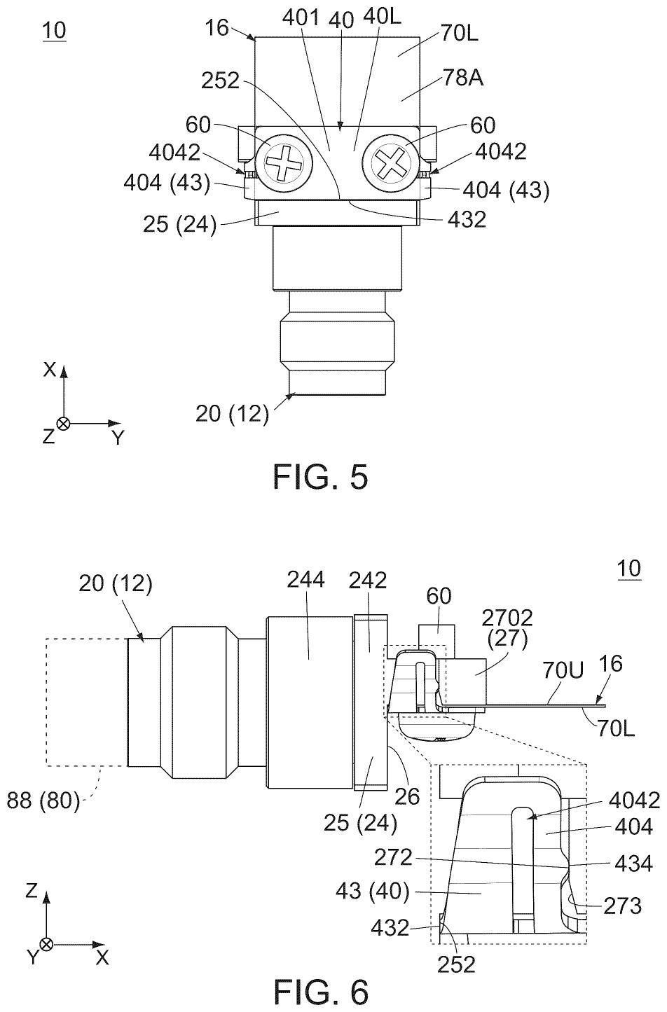

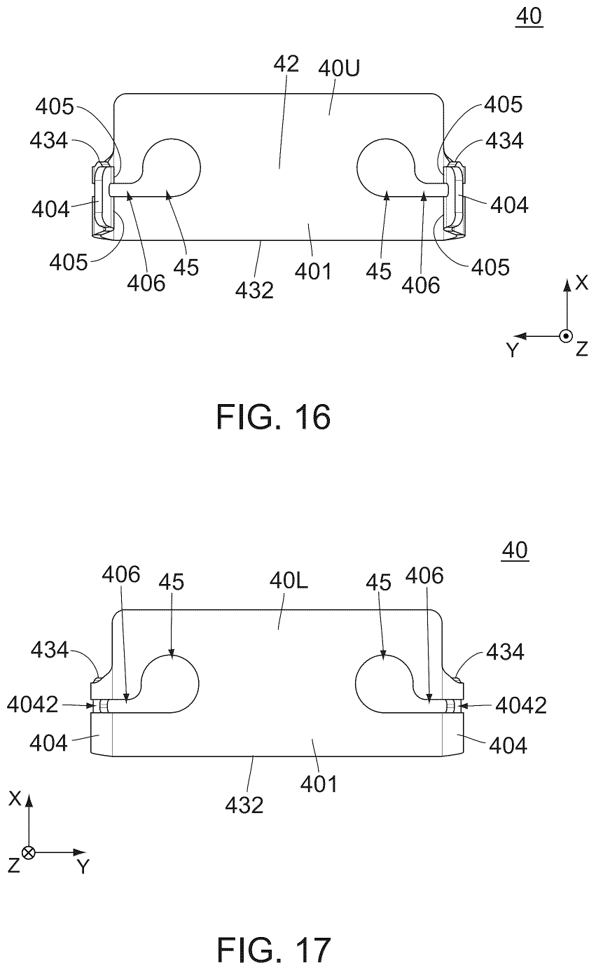

As shown in FIG. 14, the first contact portion 432 of the present embodiment faces rearward in the front-rear direction. As shown in FIG. 16, the first contact portion 432 is located rearward of any of the two second contact portions 434 in the front-rear direction. The first contact portion 432 is located between the two second contact portions 434 in the lateral direction. As shown in FIG. 5, the first contact portion 432 is in contact with the first receiving portion 252 under the connected state. Specifically, the first contact portion 432 and the first receiving portion 252 are electrically connected to each other under the connected state.

As shown in FIG. 15, each of the second contact portions 434 of the present embodiment faces forward in the front-rear direction. As shown in FIG. 16, the two second contact portions 434 are apart from each other in the lateral direction. Referring to FIGS. 6 and 19, a distance between the first contact portion 432 and any of the two second contact portions 434 in the front-rear direction is variable by the resilient deformation of the spring portion 43.

As shown in FIG. 6, the guide portion 273 guides the second contact portion 434 to the second receiving portion 272 when the fixed member 40 is attached to the coaxial connector 20. The second contact portion 434 is in contact with the second receiving portion 272 under the connected state. Under the connected state, the second contact portion 434 of the fixed member 40 made of metal is electrically connected to the second receiving portion 272 of the flange portion 25 made of metal. However, the present invention is not limited thereto. Specifically, the second contact portion 434 and the second receiving portion 272 may not be electrically connected to each other under the connected state.

Referring to FIG. 6, under the connected state, the resilient deformation of the spring portion 43 enables that the first contact portion 432 is pressed against the first receiving portion 252 while the two second contact portions 434 are pressed against the second receiving portions 272 of the two projecting portions 27, respectively. Accordingly, the connector assembly 12 of the present embodiment is configured so that the fixed member 40 is securely connected to the outer terminal 24 of the coaxial connector 20. Thus, the ground layer 78A of the substrate 16 is electrically connected to the first receiving portion 252 of the flange portion 25 of the outer terminal 24 via the fixed member 40 in a highly reliable manner when the connector assembly 12 of the present embodiment is connected to the substrate 16. That is, in the connector assembly 12 of the present embodiment, the outer terminal 24 can be stably connected to the ground layer 78A of the substrate 16 and this can definitely reduce reflection characteristics of signals propagating between the substrate 16 and the connector assembly 12.

As shown in FIG. 15, the spring portion 43 has a main portion 401 and two spring pieces 404.

Referring to FIG. 14, the main portion 401 of the present embodiment has a flat-plate shape perpendicular to the up-down direction. The main portion 401 defines a rear end of the fixed member 40 in the front-rear direction. The first contact portion 432 is provided on the main portion 401. The first contact portion 432 defines a rear end of the main portion 401 in the front-rear direction. The first contact portion 432 is a part of a rear end surface of the main portion 401. As shown in FIG. 17, the main portion 401 has two incisions 406. The two incisions 406 are located at opposite ends, respectively, of the main portion 401 in the lateral direction. Each of the incisions 406 extends in the lateral direction. Referring to FIGS. 16 and 17, the main portion 401 has an upper surface 40U and a lower surface 40L.

As shown in FIG. 15, the spring pieces 404 are provided with the second contact portions 434, respectively. The two spring pieces 404 extend upward in the up-down direction from the opposite ends, respectively, of the main portion 401 in the lateral direction. As shown in FIGS. 14 and 15, each of the spring pieces 404 is provided with a slit 4042 extending in the up-down direction. The slit 4042 enables the spring piece 404 to be resiliently deformed. The two spring pieces 404 correspond to the two incisions 406, respectively. The slit 4042 of each of the spring pieces 404 is coupled with the corresponding incision 406. Referring to FIG. 8, the two spring pieces 404 correspond to the second receiving portions 272 of the two projecting portions 27, respectively, of the coaxial connector 20. The two spring pieces 404 correspond to the guide portions 273 of the two projecting portions 27, respectively, of the coaxial connector 20.

As shown in FIG. 19, the fixed member 40 has a second distance D2 between the first contact portion 432 and any of the second contact portions 434 in the front-rear direction when the fixed member 40 is viewed alone. In other words, the fixed member 40 has the second distance D2 between the first contact portion 432 and any of the second contact portions 434 in the front-rear direction under an initial state where none of the spring pieces 404 are resiliently deformed. Referring to FIGS. 12 and 19, the second distance D2 is greater than the first distance D1. As described above, the distance between the first contact portion 432 and any of the two second contact portions 434 in the front-rear direction is variable by the resilient deformation of the spring portion 43. Accordingly, under the connected state, the spring portion 43 is sandwiched between the first receiving portion 252 and any of the second receiving portions 272 of the coaxial connector 20 via the first contact portion 432 and the second contact portions 434 while the spring portion 43 is resiliently deformed. Referring to FIGS. 6 and 12, a distance between the first contact portion 432 and any of the second contact portions 434 under the connected state is equal to the first distance D1.

As shown in FIG. 14, each of the spring pieces 404 has two third contact portions 405.

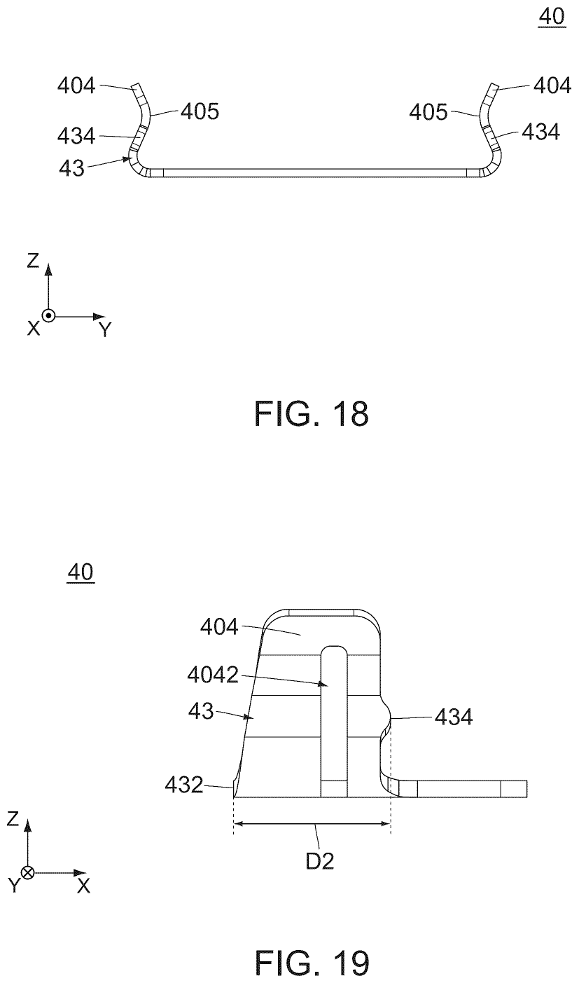

As shown in FIG. 14, the third contact portions 405 of the present embodiment faces inward in the lateral direction. Each of the third contact portions 405 is located below an upper end of the spring piece 404 in the up-down direction. Each of the third contact portions 405 is located above the first contact portion 432 in the up-down direction. In each of the spring pieces 404, the slit 4042 is located between the two third contact portions 405 in the front-rear direction. As shown in FIG. 16, each of the third contact portions 405 is located inward in the lateral direction beyond the upper end of the spring piece 404. Each of the third contact portions 405 is located between the first contact portion 432 and the second contact portion 434 in the front-rear direction. Each of the third contact portions 405 is located forward of the first contact portion 432 in the front-rear direction. Each of the third contact portions 405 is located rearward of the second contact portion 434 in the front-rear direction. Referring to FIG. 18, each of the third contact portions 405 is located above the second contact portion 434 in the up-down direction. In each of the spring pieces 404, each of the third contact portions 405 is located inward of the second contact portion 434 in the lateral direction. Referring to FIGS. 1 and 8, the third contact portion 405 is in contact with the third receiving portion 276 in the lateral direction under the connected state.

As shown in FIG. 14, the fixed member 40 has a pressed portion 42. As described later, the pressed portion 42 is a part which is configured to be pressed against the substrate 16 under the connected state. According to the present embodiment, a middle part of the upper surface 40U in the lateral direction mainly works as the pressed portion 42.

As shown in FIG. 16, the fixed member 40 of the present embodiment is formed with two fixing holes 45. Each of the fixing holes 45 passes through the fixed member 40 in the up-down direction. Each of the fixing holes 45 has a substantially circular shape in the horizontal plane. Referring to FIG. 9, the fixing holes 45 are provided at positions which correspond to those of the passing holes 72, respectively, of the substrate 16 in the horizontal plane. The thus-arranged two fixing holes 45 are apart from each other in the lateral direction and are located at positions same as each other in the front-rear direction. Referring to FIG. 17, the fixing holes 45 correspond to the incisions 406, respectively. Each of the fixing holes 45 is coupled with the corresponding incision 406. The two spring pieces 404 correspond to the two fixing holes 45, respectively. The slit 4042 of the spring piece 404 is coupled with the corresponding fixing hole 45 via the corresponding incision 406. It is noted that the slit 4042 of one of the spring pieces 404 is not coupled with the slit 4042 of a remaining one of the spring pieces 404.

The fixed member 40 of the present embodiment has the aforementioned configuration. However, the present invention is not limited thereto. For example, the shape of each of the fixing holes 45 is not specifically limited. Moreover, the number of the fixing holes 45 may be three or more.

Referring to FIG. 6, the connector assembly 12 forms the structure 10 together with the substrate 16 connected thereto. The substrate 16 of the structure is located between the fixed member 40 and each of the projecting portions 27 of the outer terminal 24 in the up-down direction. Referring to FIG. 3, the signal line 74 of the substrate 16 is pressed by the fixed member 40 from below, and thereby the signal line 74 is pressed against and in contact with the contact portion 214 of the center terminal 21. Accordingly, the contact portion 214 and the signal line 74 are electrically connected to each other. However, the present invention is not limited thereto. Specifically, the contact portion 214 and the signal line 74 may be connected to each other by soldering.

Referring to FIG. 9, each of the screws 60 of the present embodiment is a right-hand screw 60 made of metal. The screws 60 are provided so that they correspond to the passing holes 72, respectively, of the substrate 16. The number of the screws 60 of the present embodiment is two. However, the present invention is not limited thereto. For example, the connector assembly 12 may be provided with three or more of the screws 60 which have shapes different from each other. Referring to FIGS. 2 and 9, under the connected state, the screws 60 are screwed into the screw holes 28 of the projecting portions 27 through the fixing holes 45 and the passing holes 72, respectively, and thereby the screws 60 are fixed to the projecting portions 27, respectively, while the screws 60 press the fixed member 40 against the ground layer 78A of the substrate 16.

The connector assembly 12 of the present embodiment is configured to be connected to the substrate 16 by a connection method described below. The connection method described below is merely an example and can be modified as necessary.

Referring to FIGS. 8 and 9, the coaxial connector 20 and the substrate 16 are firstly arranged in the up-down direction so that the lower surface 27L of the projecting portion 27 of the coaxial connector 20 and the upper surface 70U of the substrate 16 are in contact with each other in the up-down direction while the screw hole 28 of the coaxial connector 20 and the passing hole 72 of the substrate 16 are located at positions same as each other in the horizontal plane.

Next, the fixed member 40 is arranged relative to the coaxial connector 20 and the substrate 16 in the up-down direction so that the lower surface 70L of the substrate 16 faces the upper surface 40U of the fixed member 40 in the up-down direction while each of the guide portions 273 of the coaxial connector 20 and the second contact portion 434 of the corresponding spring piece 404 of the fixed member 40 are located at positions same as each other in the horizontal plane.

After that, the fixed member 40 is moved so that it approaches the coaxial connector 20 and the substrate 16 in the up-down direction. Then, the second contact portion 434 of the fixed member 40 is brought into contact with the guide portion 273 of the coaxial connector 20 while third contact portion 405 of the fixed member 40 is brought into contact with the projecting portion 27 of the coaxial connector 20.

From this state, the fixed member 40 is further moved so that it approaches the coaxial connector 20 and the substrate 16 in the up-down direction. Then, the following occurs with the resilient deformation of the spring portion 43 of the fixed member 40: the first contact portion 432 of the fixed member 40 is moved onto the first receiving portion 252 of the coaxial connector 20; and the second contact portion 434 of the fixed member 40 rides over the guide portion 273 of the coaxial connector and then rides on the corresponding second receiving portion 272 of the coaxial connector 20. At this time, the third contact portion 405 of the fixed member 40 is moved onto the third receiving portion 276 of the coaxial connector 20. Also, at this time, the upper surface 40U of the fixed member 40 is brought into contact with the lower surface 70L of the substrate 16 in the up-down direction. As described above, each of the guide portions 273 extends upward and rearward. Accordingly, the fixed member 40 is smoothly attached to the coaxial connector 20 when the fixed member is attached to the coaxial connector 20.

In this state, the first contact portion 432 of the fixed member 40 is in contact with the first receiving portion 252 of the coaxial connector 20 in the front-rear direction, the second contact portion 434 of the fixed member 40 is in contact with the corresponding second receiving portion 272 of the coaxial connector 20 in the front-rear direction, and the third contact portion 405 of the fixed member 40 is in contact with the third receiving portion 276 of the coaxial connector 20 in the lateral direction. Also, in this state, the resilient deformation of the spring portion 43 enables that the first contact portion 432 is pressed against the first receiving portion 252 while the two second contact portions 434 are pressed against the second receiving portions 272 of the two projecting portions 27, respectively.

After that, each of the screws 60 is screwed into the screw hole 28 of the projecting portion 27 of the coaxial connector 20 through the fixing hole 45 of the fixed member 40 and the passing hole 72 of the substrate 16. Accordingly, the connector assembly 12 changes its state into the connected state where the connector assembly 12 is connected to the substrate 16. The contact portion 214 of the center terminal 21 is brought into contact with the signal line 74 of the substrate 16 under the connected state.

As shown in FIG. 6, the part of the fixed member 40 is located below the substrate 16 in the up-down direction under the connected state. Referring to FIGS. 2 and 9, under the connected state, a head of each of the screws 60 is pressed against the lower surface 40L of the fixed member 40 and presses the fixed member 40 upward. The upper surface 40U of the thus-pressed fixed member 40 presses the substrate 16 against the lower surfaces 27L of the projecting portions 27. As a result, the substrate 16 is sandwiched and held between the fixed member 40 and each of the projecting portions 27. The thus-sandwiched substrate 16 has a contact region which is located below the contact portion 214 of the center terminal 21. The pressed portion 42 (see FIG. 8) of the fixed member 40 is pressed against the contact region of the substrate 16 and supports the contact region from below. If the substrate 16 is a flexible board, the contact region of the substrate 16 is not bent even when force is applied thereto from above. The fixed member 40 is pressed against the ground layer 78A of the substrate 16 under the connected state.

That is, under the connected state, the screws 60 are screwed into the screw holes 28 of the projecting portions 27 through the fixing holes 45 and the passing holes 72, respectively, and thereby the screws 60 are fixed to the projecting portions 27, respectively, while the screws 60 press the fixed member 40 against the ground layer 78A of the substrate 16.

Referring to FIGS. 4 and 9, the outer terminal 24 is grounded to the ground layer 78A of the lower surface 70L of the substrate 16 via the projecting portions 27, the screws 60 and the fixed member 40 under the connected state.

Although the outer terminal 24 of the present embodiment is configured so that the second receiving portion 272 is the part of the rear surface of the second portion 2702 of the projecting portion 27 in the front-rear direction as described above, the present invention is not limited thereto. Specifically, the outer terminal 24 may be modified as follows: the projecting portion 27 is provided with a ditch or recess which is opened downward; and an inner surface of the ditch or recess includes a surface facing rearward; and the surface functions as the second receiving portion 272. In this case, under the connected state, the spring piece 404 of the fixed member 40 is accommodated into the ditch or recess from below while the second contact portion 434 of the spring piece 404 is brought into contact in the front-rear direction with the second receiving portion 272 which is the surface of the inner surface of the ditch or recess and which is the surface facing rearward.

The configuration of the fixed member 40 of the connector assembly 12 is not limited to the aforementioned embodiment. For example, the fixed member 40 can be modified as described below.

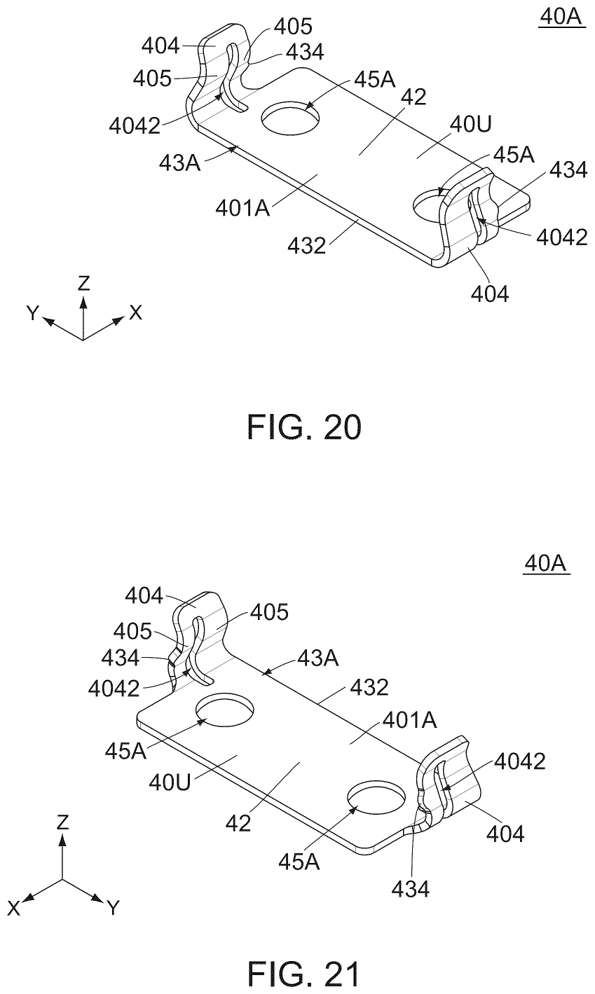

As shown in FIG. 20, a fixed member 40A according to a first modification of the present invention has a spring portion 43A, a first contact portion 432 and two second contact portions 434. The first contact portion 432 and the second contact portion 434 have configurations same as those of the first contact portion 432 and the second contact portion 434 of the aforementioned embodiment. Accordingly, a detailed explanation thereabout is omitted.

Referring to FIG. 20, the spring portion 43A of the present modification is resiliently deformable and supports all of the first contact portion 432 and the two second contact portions 434. The spring portion 43A defines a rear end of the fixed member 40A in the front-rear direction.

Referring to FIGS. 9 and 20, under a connected state where a connector assembly (not shown) according to the first modification of the present invention, which comprises the coaxial connector 20, the fixed member 40A and the two screws 60, is connected to the substrate 16, the resilient deformation of the spring portion 43A enables that the first contact portion 432 is pressed against the first receiving portion 252 while the two second contact portions 434 are pressed against the second receiving portions 272 of the two projecting portions 27, respectively. Accordingly, the connector assembly of the present modification is also configured so that the fixed member 40A is securely connected to the outer terminal 24 of the coaxial connector 20. Thus, the ground layer 78A of the substrate 16 is electrically connected to the first receiving portion 252 of the flange portion 25 of the outer terminal 24 via the fixed member 40A in a highly reliable manner when the connector assembly of the present modification is connected to the substrate 16. In other words, also in the connector assembly of the present modification, the outer terminal 24 can be stably connected to the ground layer 78A of the substrate 16 and this can definitely reduce reflection characteristics of signals propagating between the substrate 16 and the connector assembly.

As shown in FIG. 20, the spring portion 43A has a main portion 401A and two spring pieces 404. The spring piece 404 of the present modification has a configuration same as that of the spring piece 404 of the aforementioned embodiment. Accordingly, a detailed explanation thereabout is omitted.

Referring to FIG. 20, the main portion 401A of the present modification has a flat-plate shape perpendicular to the up-down direction. The main portion 401A defines a rear end of the fixed member 40A in the front-rear direction. The first contact portion 432 is provided on the main portion 401A. The first contact portion 432 defines a rear end of the main portion 401A in the front-rear direction. The first contact portion 432 is a part of a rear end surface of the main portion 401A. Dissimilar to the aforementioned embodiment, the main portion 401A of the present modification has no incision 406.

Referring to FIG. 20, the fixed member 40A has a second distance between the first contact portion 432 and any of the second contact portions 434 in the front-rear direction when the fixed member 40A is viewed alone. In other words, the fixed member 40A has the second distance between the first contact portion 432 and any of the second contact portions 434 in the front-rear direction under an initial state where none of the spring pieces 404 are resiliently deformed. Referring to FIGS. 12 and 20, the second distance is greater than the first distance D1. Accordingly, under the connected state, the spring portion 43A is sandwiched between the first receiving portion 252 and any of the second receiving portions 272 of the coaxial connector 20 via the first contact portion 432 and the second contact portions 434 while the spring portion 43A is resiliently deformed.

As shown in FIG. 20, the fixed member 40A has a pressed portion 42. The pressed portion 42 of the present modification has a configuration same as that of the pressed portion 42 of the aforementioned embodiment. Accordingly, a detailed explanation thereabout is omitted.

As shown in FIG. 21, the fixed member 40A of the present modification is formed with two fixing holes 45A. Each of the fixing holes 45A passes through the fixed member 40A in the up-down direction. Each of the fixing holes 45A has a circular shape in the horizontal plane. Referring to FIGS. 9 and 20, the fixing holes 45A are provided at positions which correspond to those of the passing holes 72, respectively, of the substrate 16 in the horizontal plane. The thus-arranged two fixing holes 45A are apart from each other in the lateral direction and are located at positions same as each other in the front-rear direction. The two spring pieces 404 correspond to the two fixing holes 45A, respectively. As described above, the main portion 401A of the present modification has no incision 406. Accordingly, a slit 4042 of the spring piece 404 of the present modification is not coupled with the corresponding fixing hole 45A.

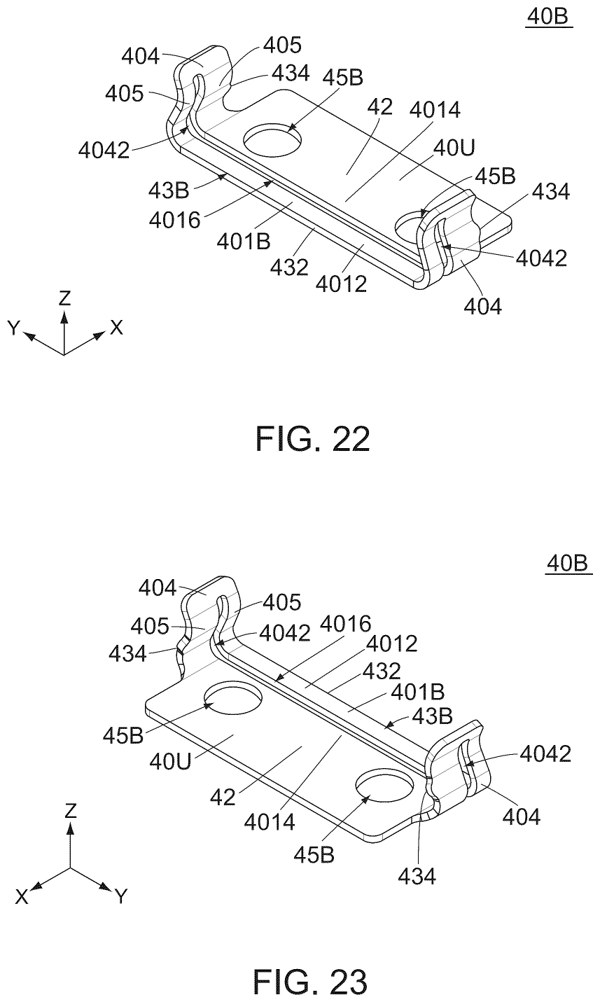

As shown in FIG. 22, a fixed member 40B according to a second modification of the present invention has a spring portion 43B, a first contact portion 432 and two second contact portions 434. The first contact portion 432 and the second contact portion 434 have configurations same as those of the first contact portion 432 and the second contact portion 434 of the aforementioned embodiment. Accordingly, a detailed explanation thereabout is omitted.

Referring to FIG. 22, the spring portion 43B of the present modification is resiliently deformable and supports all of the first contact portion 432 and the two second contact portions 434. The spring portion 43B defines a rear end of the fixed member 40B in the front-rear direction.

Referring to FIGS. 9 and 22, under a connected state where a connector assembly (not shown) according to the second modification of the present invention, which comprises the coaxial connector 20, the fixed member 40B and the two screws 60, is connected to the substrate 16, the resilient deformation of the spring portion 43B enables that the first contact portion 432 is pressed against the first receiving portion 252 while the two second contact portions 434 are pressed against the second receiving portions 272 of the two projecting portions 27, respectively. Accordingly, the connector assembly of the present modification is also configured so that the fixed member 40B is securely connected to the outer terminal 24 of the coaxial connector 20. Thus, the ground layer 78A of the substrate 16 is electrically connected to the first receiving portion 252 of the flange portion 25 of the outer terminal 24 via the fixed member 40B in a highly reliable manner when the connector assembly of the present modification is connected to the substrate 16. In other words, also in the connector assembly of the present modification, the outer terminal 24 can be stably connected to the ground layer 78A of the substrate 16 and this can definitely reduce reflection characteristics of signals propagating between the substrate 16 and the connector assembly.

As shown in FIG. 22, the spring portion 43B has a main portion 401B and two spring pieces 404. The spring piece 404 of the present modification has a configuration same as that of the spring piece 404 of the aforementioned embodiment. Accordingly, a detailed explanation thereabout is omitted.

Referring to FIG. 22, the main portion 401B of the present modification defines a rear end of the fixed member 40B in the front-rear direction. The main portion 401B has a first main portion 4012 and a second main portion 4014. The first main portion 4012 is located rearward of the second main portion 4014 in the front-rear direction. The first main portion 4012 and the second main portion 4014 are separated from each other with a long cut 4016 put therebetween. In other words, the long cut 4016 is located between the first main portion 4012 and the second main portion 4014 in the front-rear direction. The first contact portion 432 is provided on the main portion 401B. Specifically, the first contact portion 432 is provided on the first main portion 4012. The first contact portion 432 defines a rear end of the main portion 401B in the front-rear direction. The first contact portion 432 defines a rear end of the first main portion 4012 in the front-rear direction. The first contact portion 432 is a part of a rear end surface of the main portion 401B. Specifically, the first contact portion 432 is a part of a rear end surface of the first main portion 4012.

Referring to FIG. 22, the fixed member 40B has a second distance between the first contact portion 432 and any of the second contact portions 434 in the front-rear direction when the fixed member 40B is viewed alone. In other words, the fixed member 40B has the second distance between the first contact portion 432 and any of the second contact portions 434 in the front-rear direction under an initial state where none of the spring pieces 404 are resiliently deformed. Referring to FIGS. 12 and 22, the second distance is greater than the first distance D1. Accordingly, under the connected state, the spring portion 43B is sandwiched between the first receiving portion 252 and any of the second receiving portions 272 of the coaxial connector 20 via the first contact portion 432 and the second contact portions 434 while the spring portion 43B is resiliently deformed.

As shown in FIG. 22, the fixed member 40B has a pressed portion 42. The pressed portion 42 of the present modification has a configuration same as that of the pressed portion 42 of the aforementioned embodiment. Accordingly, a detailed explanation thereabout is omitted.

As shown in FIG. 23, the fixed member 40B of the present modification is formed with two fixing holes 45B. Each of the fixing holes 45B passes through the fixed member 40B in the up-down direction. Each of the fixing holes 45B has a circular shape in the horizontal plane. Referring to FIGS. 9 and 22, the fixing holes 45B are provided at positions which correspond to those of the passing holes 72, respectively, of the substrate 16 in the horizontal plane. The thus-arranged two fixing holes 45B are apart from each other in the lateral direction and are located at positions same as each other in the front-rear direction. The two spring pieces 404 correspond to the two fixing holes 45B, respectively. A slit 4042 of the spring piece 404 of the present modification is not coupled with the corresponding fixing hole 45B. The slits 4042 of the two spring pieces 404 are coupled with each other in the lateral direction. Specifically, the slits 4042 of the two spring pieces 404 are coupled with each other via the long cut 4016. By this structure, the spring portion 43B of the present modification is easily resiliently deformable as compared to the spring portions 43, 43A of the aforementioned embodiment and first modification.

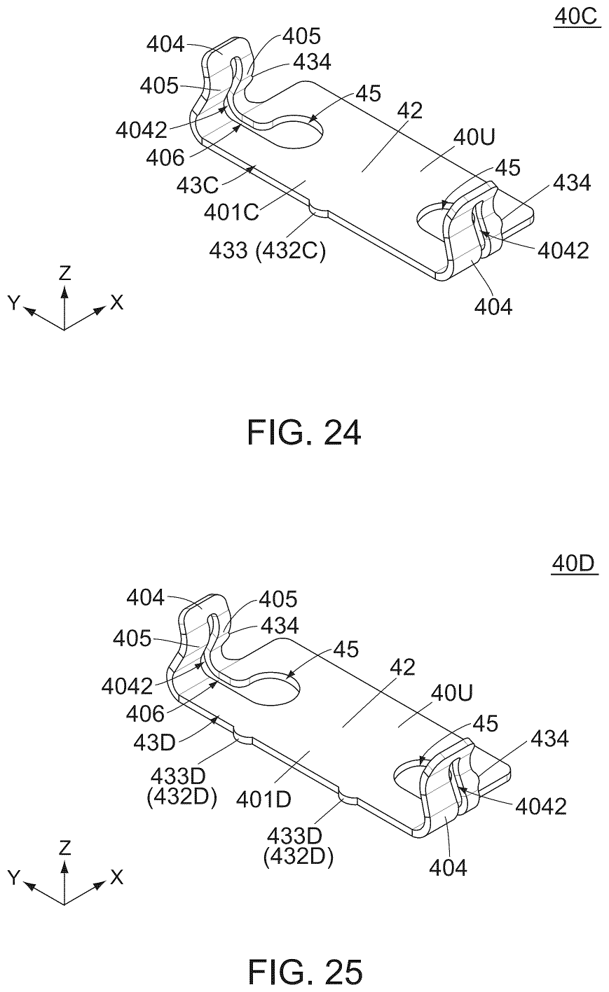

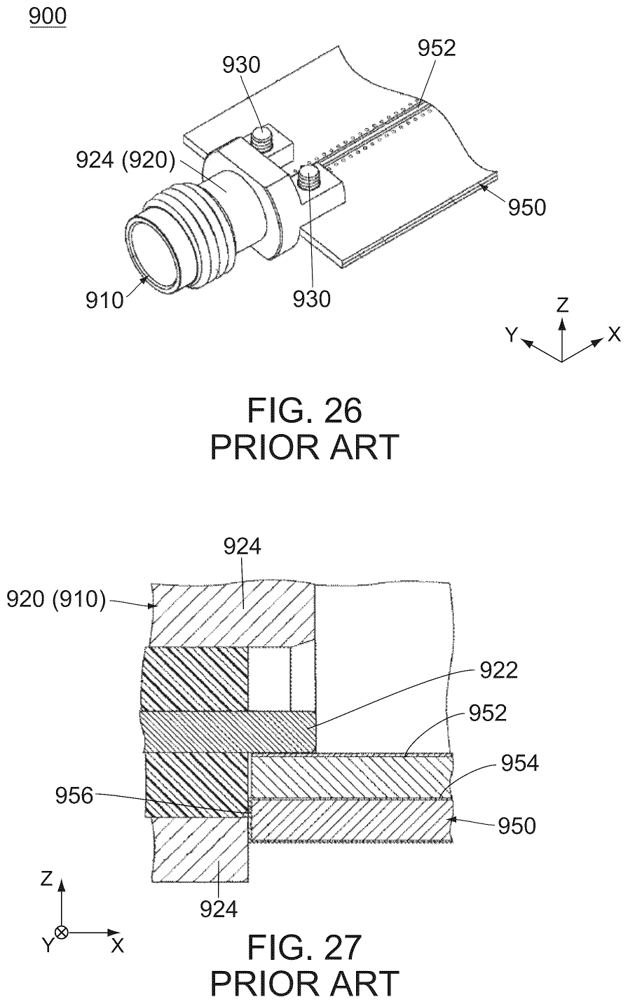

As shown in FIG. 24, a fixed member 40C according to a third modification of the present invention has a spring portion 43C, a first contact portion 432C and two second contact portions 434. Specifically, the spring portion 43C has a main portion 401C and two spring pieces 404. The spring portion 43C and the second contact portion 434 have configurations same as those of the spring portion 43 and the second contact portion 434 of the aforementioned embodiment. Accordingly, a detailed explanation thereabout is omitted.

As shown in FIG. 24, the first contact portion 432C of the present modification faces rearward in the front-rear direction. The first contact portion 432C is located rearward of any of the two second contact portions 434 in the front-rear direction. The first contact portion 432C is located between the two second contact portions 434 in the lateral direction. The first contact portion 432C consists of a single protrusion 433. The protrusion 433 is located at a middle of the fixed member 40C in the lateral direction. The protrusion 433 is supported by the spring portion 43C so that the protrusion 433 protrudes rearward in the front-rear direction. Referring to FIGS. 24 and 5, the first contact portion 432C is in contact with the first receiving portion 252 under a connected state where a connector assembly (not shown) according to the third modification of the present invention, which comprises the coaxial connector 20, the fixed member 40C and the two screws 60, is connected to the substrate 16. Specifically, the first contact portion 432C and the first receiving portion 252 are electrically connected to each other under the connected state. Referring to FIGS. 24 and 3, the protrusion 433 is located between the two projecting portions 27 in the lateral direction under the connected state. The protrusion 433 is located at a position same as a position of the contact portion 214 of the center terminal 21 in the lateral direction under the connected state. The protrusion 433 is located in the vicinity of the contact portion 214 of the center terminal 21 under the connected state.

Referring to FIGS. 8 and 24, under the connected state, the resilient deformation of the spring portion 43C enables that the first contact portion 432C is pressed against the first receiving portion 252 while the two second contact portions 434 are pressed against the second receiving portions 272 of the two projecting portions 27, respectively. Accordingly, the connector assembly of the present modification is also configured so that the fixed member 40C is securely connected to the outer terminal 24 of the coaxial connector 20. Thus, the ground layer 78A of the substrate 16 is electrically connected to the first receiving portion 252 of the flange portion 25 of the outer terminal 24 via the fixed member 40C in a highly reliable manner when the connector assembly of the present modification is connected to the substrate 16. In other words, also in the connector assembly of the present modification, the outer terminal 24 can be stably connected to the ground layer 78A of the substrate 16 and this can definitely reduce reflection characteristics of signals propagating between the substrate 16 and the connector assembly.

As described above, the first contact portion 432C, which is located in the vicinity of the contact portion 214 of the center terminal 21 of the coaxial connector 20, is pressed against the first receiving portion 252 along the front-rear direction under the connected state. This enables the fixed member 40C of the present modification to be always in contact with the flange portion 25 at the vicinity of the contact portion 214 of the center terminal 21 of the coaxial connector 20 under the connected state.

As shown in FIG. 25, a fixed member 40D according to a fourth modification of the present invention has a spring portion 43D, a first contact portion 432D and two second contact portions 434. Specifically, the spring portion 43D has a main portion 401D and two spring pieces 404. The spring portion 43D and the second contact portion 434 have configurations same as those of the spring portion 43 and the second contact portion 434 of the aforementioned embodiment. Accordingly, a detailed explanation thereabout is omitted.

As shown in FIG. 25, the first contact portion 432D of the present modification faces rearward in the front-rear direction. The first contact portion 432D is located rearward of any of the two second contact portions 434 in the front-rear direction. The first contact portion 432D is located between the two second contact portions 434 in the lateral direction. The first contact portion 432D consists of two protrusions 433D. However, the present invention is not limited thereto. Specifically, the first contact portion 432D may comprise at least one protrusion 433D. The two protrusions 433D are arranged mirror symmetrically to each other with respect to the plane perpendicular to the lateral direction. Each of the protrusions 433D is supported by the spring portion 43D so that each of the protrusions 433D protrudes rearward in the front-rear direction. Referring to FIGS. 25 and 5, the first contact portion 432D is in contact with the first receiving portion 252 under a connected state where a connector assembly (not shown) according to the fourth modification of the present invention, which comprises the coaxial connector 20, the fixed member 40D and the two screws 60, is connected to the substrate 16. Specifically, the first contact portion 432D and the first receiving portion 252 are electrically connected to each other under the connected state. Referring to FIGS. 25 and 3, the two protrusions 433D are located at opposite sides, respectively, of the contact portion 214 of the center terminal 21 in the lateral direction under the connected state. Each of the protrusions 433D is located around the contact portion 214 of the center terminal 21 under the connected state.

Referring to FIGS. 25 and 8, under the connected state, the resilient deformation of the spring portion 43D enables that the first contact portion 432D is pressed against the first receiving portion 252 while the two second contact portions 434 are pressed against the second receiving portions 272 of the two projecting portions 27, respectively. Accordingly, the connector assembly of the present modification is also configured so that the fixed member 40D is securely connected to the outer terminal 24 of the coaxial connector 20. Thus, the ground layer 78A of the substrate 16 is electrically connected to the first receiving portion 252 of the flange portion 25 of the outer terminal 24 via the fixed member 40D in a highly reliable manner when the connector assembly of the present modification is connected to the substrate 16. In other words, also in the connector assembly of the present modification, the outer terminal 24 can be stably connected to the ground layer 78A of the substrate 16 and this can definitely reduce reflection characteristics of signals propagating between the substrate 16 and the connector assembly.

As described above, the first contact portion 432D, which is located around the contact portion 214 of the center terminal 21 of the coaxial connector 20, is pressed against the first receiving portion 252 along the front-rear direction under the connected state. This enables the fixed member 40D of the present modification to be always in contact with the flange portion 25 around the contact portion 214 of the center terminal 21 of the coaxial connector 20 under the connected state.

Although the specific explanation is made about the embodiment and modifications, the aforementioned embodiment and modifications can be further variously modified and can be variously combined to each other.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector assembly configured to be connected to a substrate, wherein:
the substrate is formed with two passing holes, each of the passing holes passing through the substrate in an up-down direction, the substrate having an upper surface and a lower surface in the up-down direction, the upper surface of the substrate being formed with a signal line, the signal line being located between the two passing holes in a lateral direction perpendicular to the up-down direction, the lower surface of the substrate being formed with a ground layer;
the connector assembly comprises a coaxial connector, a fixed member and two screws;
the coaxial connector is configured to be attached to a distal end of a coaxial cable;
the coaxial connector comprises an outer terminal and a center terminal;
the outer terminal has a flange portion and two projecting portions;
the flange portion has a first receiving portion;
the first receiving portion faces forward in a front-rear direction perpendicular to both the up-down direction and the lateral direction;
the two projecting portions are apart from each other in the lateral direction;
each of the projecting portions extends forward in the front-rear direction from the flange portion;
each of the projecting portions is formed with a screw hole;
each of the projecting portions is provided with a second receiving portion;
the second receiving portion faces at least rearward in the front-rear direction;
the fixed member is made of metal;
a part of the fixed member is located below the substrate in the up-down direction under a connected state where the connector assembly is connected to the substrate;
the ground layer of the substrate is electrically connected to the first receiving portion of the flange portion via the fixed member under the connected state;
the fixed member is formed with two fixing holes;
each of the fixing holes passes through the fixed member in the up-down direction;
the fixed member has a spring portion, a first contact portion and two second contact portions;
the spring portion is resiliently deformable and supports all of the first contact portion and the two second contact portions;
the first contact portion is located rearward of any of the two second contact portions in the front-rear direction;
the two second contact portions are apart from each other in the lateral direction;
the fixed member has a distance between the first contact portion and any of the two second contact portions in the front-rear direction;
the distance is variable by resilient deformation of the spring portion;
under the connected state, the resilient deformation of the spring portion enables that the first contact portion is pressed against the first receiving portion while the two second contact portions are pressed against the second receiving portions of the two projecting portions, respectively; and
under the connected state, the screws are screwed into the screw holes of the projecting portions through the fixing holes and the passing holes, respectively, and thereby the screws are fixed to the projecting portions, respectively, while the screws press the fixed member against the ground layer of the substrate.

2. The connector assembly as recited in claim 1, wherein:
the spring portion has a main portion and two spring pieces;
the spring pieces are provided with the second contact portions, respectively;
the main portion has opposite ends in the lateral direction;
the two spring pieces extend upward in the up-down direction from the opposite ends, respectively;
each of the spring pieces is provided with a slit extending in the up-down direction; and
the slit enables the spring piece to be resiliently deformed.

3. The connector assembly as recited in claim 1, wherein:
the first contact portion comprises at least one protrusion; and
the protrusion is supported by the spring portion so that the protrusion protrudes rearward in the front-rear direction.
